(19) United States
(12) Patent Application Publication
(10) Pub. No.: US 2008/0196828 A1
(43) Pub. Date: Aug. 21, 2008

(54) Electrically Disbonding Adhesive Compositions and Related Methods

(76) Inventor: Michael D. Gilbert, Brookline, NH (US)

Correspondence Address: GOODWIN PROCTER LLP;PATENT ADMINISTRATOR, EXCHANGE PLACE, BOSTON, MA, 02109-2881, US

(21) Appl. No.: 12/104,747

(22) Filed: Apr. 17, 2008

Related U.S. Application Data
(63) Continuation-in-part of application No. 11/435,622, filed on May 17, 2006.
Application No. 11/435,622 is a continuation-in-part of application No. 09/352,976, filed on Jul. 14, 1999, now Pat. No. 7,332,218.

(51) Int. Cl. B32B 37/12; H01B 1/12; B29C 65/54

(52) U.S. Cl. 156/274.8; 252/500

(57) ABSTRACT

Adhesive compositions and methods of bonding and disbanding involve materials that include a polymer and an electrolyte, wherein the electrolyte provides sufficient ionic conductivity to enable a faradaic reaction at a bond formed between the composition and an electrically conductive surface, allowing the composition to disbond from the surface at room temperature. In some embodiments, the polymer component comprises or consists essentially of a thermoplastic polymer.

### CROSS-REFERENCE TO RELATED APPLICATION

This is a continuation-in-part of U.S. Ser. No. 11/435,622, filed on May 17, 2006, which is itself a continuation-in-part of U.S. Ser. No. 09/352,976, filed on Jul. 14, 1999, the entire disclosure of which is hereby incorporated by reference.

### STATEMENT AS TO FEDERALLY SPONSORED RESEARCH

This invention was made with United States government support under Contract No. F08635-97-C-0036 awarded by the U.S, Department of the Air Force and under Contract No. DE-FG02-05ER84227 awarded by the U.S. Department of Energy. The United States government has certain rights to this invention.

### FIELD OF THE INVENTION

The invention relates to adhesives and, in particular, to adhesives forming bonds that may be weakened electrically.

### BACKGROUND

Hot-melt adhesives are materials or mixtures that undergo a phase change over a narrow temperature range, transitioning between a fluid state at higher temperatures and a crystalline or amorphous solid state at lower temperatures. To form an adhesive bond, the hot-melt is applied to a surface in the molten state or is applied as a solid and subsequently melted on the surface. A second surface is then brought into contact with the adhesive while it is still molten. Upon cooling the hot-melt hardens, forming an adhesive bond between the two surfaces.

Hot-melt adhesives are particularly advantageous for high-volume, low-cost manufacturing because of the simplicity of applying the adhesive to surfaces for bonding, the rapidity with which the adhesive bond is formed, and because a hot-melt adhesive, while typically a mixture of materials, may be provided as a single component that does not require mixing or the addition of catalysts to initiate the chemical reaction forming an adhesive bond.

To separate the bond formed by a conventional hot-melt adhesive, it is necessary to heat the bond to a temperature above the melting temperature of the adhesive. In practice, however, it is often impractical to apply sufficient heat to a large bonded assembly or to bonded parts that are thermally sensitive. Furthermore, molten adhesives typically retain substantial adhesive properties, such as a high degree of tack, which hinders separation and prevents clean surface separation. Instead, the molten adhesive separates by cohesive failure, leaving behind a stringy residue on the separated surfaces.

The ability to easily separate an adhesive bond provides many benefits. Disbonding—i.e., the release of an adhesive bond—may be desired when there is a need to disassemble a temporary structure or a previously bonded assembly of items, e.g., to allow repair, refurbishment, replacement or renovation operations. Simplified disbanding procedures also facilitate end-of-life recycling of materials and components from adhesively bonded goods and structures. Moreover, reversible bonding is beneficial for packaging or for use in securing items during shipping.

### DESCRIPTION

### Summary of the Invention

Embodiments of the present invention provide a meltable composition capable of forming moderately strong bonds to electrically conductive substrates, and which can be removed by application of a low-power direct current without damage to the substrates. The compositions are useful in providing both permanent and temporary bonds that can be easily removed when desired.

Electrochemically disbondable compositions in accordance herewith possess a hot-melt (i.e., thermoplastic) adhesive functionality and an electrolyte functionality. Such compositions undergo thermal transitions between a liquid and solid state and form an adhesive bond to a substrate to which it is applied. The electrolyte functionality provides sufficient ionic conductivity to the composition to support faradaic reactions at the interfaces between the composition and electrically conductive surfaces in contact with the composition. The adhesive bond is weakened at the interface by application of an electrical potential across the interface. Desirably the adhesive bond is substantially weakened, i.e., the adhesive bond strength is reduced to less than 50% and often less than 10% of the initial bond strength. In some cases, the bond strength is reduced to virtually zero after electrical debonding.

The term “adhesive functionality” means the ability of a material or mixture of materials to join to a substrate by mechanical interlocking or chemical or physical interactions and to adhere to the substrate by virtue of this bond. Adhesive or “matrix” functionality also provides mechanical strength to the composition, such that the material is capable of transferring load between substrates.

The “electrolyte functionality” of a material refers to the ability of the material to conduct ions, either cations or anions or both. The ions are provided by a salt added to the material or are chemically incorporated into the material as an ionomer, that is, a polymer containing ionized groups. The electrolyte functionality is understood to derive from the ability of the composition to solvate ions of at least one polarity.

The term “faradaic reaction” means an electrochemical reaction in which a material is oxidized or reduced.

In a first aspect, therefore, the invention relates to a hot-melt adhesive composition comprising a thermoplastic component and an electrolyte. The electrolyte provides sufficient ionic conductivity to the composition to enable a faradaic reaction at a bond formed between the composition and an electrically conductive surface, allowing the composition to disbond from the surface. The electrolyte functionality may comprise, for example, an ion-solvating molecule selected from the group consisting of low molecular weight alkoxides, alcohols, alkyl carbonates, cyclic esters, nitriles, amides and ureas.

In some embodiments, the thermoplastic component comprises a thermoplastic polymer. The composition may include a tackifier and/or a wax and/or a salt. Suitable tackifiers include terpene resins, rosin derivatives, cyclical aliphatic hydrocarbons, aliphatic aromatic hydrocarbons, and/or low-molecular-weight phenolic resins. Suitable waxes include microcrystalline waxes, paraffin wax, Fischer-Tropsch wax and/or PEG-based waxes. A suitable salt is is sodium perchlorate.

In various embodiments, a composition in accordance with the invention includes one or more of a plasticizing oil, a solvent, an oxidation inhibitor and/or a stabilizer.

The composition may comprise a second thermoplastic component capable of coordinating ions. Either or both of the thermoplastic components may comprise at least one of of ethylene vinyl acetate copolymers, ethylene acrylic copolymers or polyesteramides. The second thermoplastic may be, for example, an alkylated phenol-co-formaldehyde.

In some embodiments, the composition exhibits an ionic conductivity between 10⁻⁵ S/cm and 10⁻⁸ S/cm. The adhesive bond may be substantially weakened by the passage of 100 mC/cm² of bond area.

In another aspect, the invention relates to an adhesive composition comprising a polymer and an electrolyte. The electrolyte provides sufficient ionic conductivity to the composition to enable a faradaic reaction at a bond formed between the composition and an electrically conductive surface, allowing the composition to disbond from the surface at room temperature.

In yet another aspect, the invention relates to a method of forming an electrically weakening adhesive bond. In various embodiments, the method comprises the steps of applying a hot-melt adhesive to a first electrically conductive surface; contacting the hot-melt adhesive with a second electrically conductive surface; allowing formation of an adhesive bond; and applying a voltage between the electrically conducting surfaces whereby adhesion at at least one interface between the hot-melt adhesive and a conductive surface is substantially weakened. In some embodiments, the voltage is between 5 V and 100 V. Furthermore, the adhesive bond may be weakened without melting the adhesive.

Still another aspect of the invention relates to a method of forming an electrically weakening adhesive bond by applying a hot-melt adhesive to a first electrically conductive surface, contacting the hot-melt adhesive with a second electrically conductive surface, allowing formation of an adhesive bond, applying a voltage of a first polarity between the electrically conducting surfaces, and applying a voltage of a second polarity between the electrically conducting surfaces. The second polarity is the reverse of the first polarity, whereby adhesion at both of the interfaces between the hot-melt adhesive and the conductive surfaces are substantially weakened. In some embodiments, the voltage is between 5 V and 100 V. Furthermore, the adhesive bond may be weakened without melting the adhesive.

### BRIEF DESCRIPTION OF THE DRAWINGS

The invention is described with reference to the figures, which are presented for the purpose of illustration only and which are not limiting of the invention, and in which:

FIGS. 1A-1C are cross-sectional illustrations of a bonded joint using the composition of the invention, and disbanding of this joint; and

FIGS. 2A-2C are cross-sectional illustrations of a bonded joint incorporating conductive coatings in the bonded structure, and disbanding of this joint.

### DETAILED DESCRIPTION

In various embodiments, the invention provides a hot-melt adhesive capable of forming an adhesive bond that can be electrically weakened to facilitate disbanding. Embodiments of the invention also comprise methods of using a disbondable hot-melt adhesive to form a bonded structure and subsequently disassembling the structure by the application of electricity.

In general, the electrochemically disbondable compositions described herein possess matrix functionality, which provides cohesive strength and adhesion, and electrolyte functionality, which provides sufficient ionic conductivity to support faradaic reactions at the interface between the composition and an electrically conductive substrate in contact with the composition. It is presumed that faradaic reactions occur at interfaces of the composition and electrically conductive substrates during electrical disbanding as evidenced by the establishment of an ionic current. While not being bound to any particular mechanism, these faradaic reactions may contribute to the weakening of the adhesive bond by electrochemical degradation of the adhesive composition, by digestion of the electrically conducting substrate, by generation by faradaic reactions of corrosive species that degrade the composition or substrate, by generation of gaseous products at this interface, by the transport and accumulation of liquids and other mobile species at this interface by ionic flow or the establishment of an electric field or by the dewetting of the composition from the electrically conductive substrate driven by the flow of ions, the establishment of an electric field or by the accumulation of ions, solvents or other mobile species at this interface.

Matrix functionality may be provided by one of the general classes of polymers and polymer resins used in bonding or coating surfaces. The materials may be prepared from commercially available polymer resins, often without modification. The polymer is preferably a thermoplastic, which is thermally tractable and can be made to soften or flow with the application of heat. These polymers are linear or lightly branched and are typically soluble in some solvent. Exemplary thermoplastic polymers include acrylics, styrene/butadiene block copolymers (e.g., polyesters and polyamides) and the like.

Such polymers are well suited to provide the matrix functionality of the composition; however, in order to support a faradaic reaction at an electrically conductive substrate, the disbanding composition also must possess sufficient ion conductivity to permit ion transport within the composition. Modification of the polymer to promote or support ionic conductivity or to promote ion solubility therefore is contemplated.

In one embodiment of the invention, the polymer includes ion-coordinating moieties that are capable of solvating ions, and in particular cations, of the electrolyte. Exemplary ion-coordinating moieties include alkoxy groups, such as methoxy or ethoxy, and oligoethers, such as polyethylene oxide and the like, disulfide moieties, thioalkyl groups, alkyl or alkenyl nitrile groups, ester groups, amide groups, imides, ureas, urethanes and polyvinylidene fluoride groups.

Another manner in which the polymer supports or promotes the dissolution and diffusional movement of the ions found in the electrolyte is to have a glass transition temperature T_{g} that is below the disbanding temperature. This can be achieved by increasing the disbanding temperature, or adding a plasticizer to the polymer composition. The term “plasticizer” means an electrochemically stable additive that tends to increase the molecular mobility of the composition. Exemplary plasticizers include alkyl carbonates, low molecular weight alkoxides, cyclic esters, alcohols, nitrites, amides and ureas. Many other plasticizers well-known to skilled artisans may also be employed advantageously to lower T_{g}. It can be additionally advantageous if the plasticizing molecules are capable of solvating ions, as are the above-mentioned exemplary plasticizers. By solvating ions, the plasticizer additive increases the concentration of salts that may be added to the composition to provide ionic conductivity.

In some embodiments of the invention, the electrochemically disbondable composition includes a separate electrolyte phase to provide the electrolyte functionality of the disbondable composition. An electrolyte may be used in combination with any of the above-mentioned polymers. The electrolyte may be an ionically solvating molecule, including a plasticizer, or an oligomer or polymer also capable of solvating ions. Typically, ion solvation is obtained with polar molecules or molecules that are easily polarized. The electrolyte may also constitute a portion or region of a polymer which is added to the composition. For example, the disbondable composition may include a block or graft copolymer having regions of high ionic conductivity and regions having some other desirable property, such as compatibility with the polymer resin. The polymer resin-miscible domains promote dispersion of the block copolymer throughout the entire resin, with the polar, ionically conductive regions associating into separate domains or micelles. Without the polymer resin-miscible domains, certain combinations of polymer and electrolyte may not be sufficiently compatible to form a cohesive composition and mechanical and/or adhesive strength would be compromised.

The electrolyte functionality of the disbondable composition provides ionic conductivity sufficient to maintain a faradaic reaction at an interface with an electrically conductive surface. Sufficient conductivity may be readily established by preparing a composition and applying a voltage across a bondline with an electrically conductive substrate. If current flow is observed, a faradaic reaction at the bondline may be assumed. Sufficient ionic conductivity also may be empirically observed by applying a voltage across the bondline and noting whether the bond is weakened. Compositions with ionic conductivities in the range of 10⁻¹¹ to 10⁻⁵ Siemen (S) per cm² at room temperature are considered within the scope of the invention. Materials having higher ionic conductivities require shorter disbanding times. Compositions with ionic conductivities in the range of 10⁻⁹ to 10⁻⁷ S/cm² at room temperature are preferred.

The electrolyte is desirably ionically conductive and capable of supporting ion diffusion of a salt solvated therein. In most embodiments, complex ion salts are added to the composition to provide ionic conductivity. Suitable salts include alkali metal, alkaline earth and ammonium salts. Preferred salts include alkali metal, alkaline earth and ammonium salts of polyatomic, high-dissociation-constant anions, such as hexafluorophosphate, tetrafluoroborate, hexafluoroantimonate, trifluoromethane sulfonate, trifluromethane sulfonimide and perchlorate. Many other salts well known to skilled artisans may be advantageously employed.

In another embodiment, the electrolyte functionality is provided by an ionomer. The ionomer is a polymer or oligomer with ionized groups that provide ions capable of being solvated in the composition.

The electrolyte is included in the disbondable composition in an amount sufficient to provide the requisite ionic conductivity to support the faradaic reaction of the disbanding process. The actual amount of electrolyte used in a particular composition is dependent on the ionic conductivity of the polymer and the ability of the electrolyte to form a continuous conductive pathway within the composition. While a continuous pathway is not absolutely required, it promotes the efficiency of the process. Where ions are required to tunnel through regions of higher resistance, higher voltages and longer times are required for disbanding.

In preferred embodiments, approximately equal volumes of the matrix polymer and the electrolyte are used, although a wider range of compositions is contemplated as within the scope of the invention. Those skilled in the art are aware that a wide range of compositions may be used to obtain a substantially continuously conductive electrolyte phase depending upon the materials used and how the composition phase separates. In some instances, a seemingly high level of electrolyte, e.g., 50 vol %, may be added without overly compromising the adhesive or mechanical properties of the disbondable composition. The composition is presumed to maintain its strength due to the ionic strengthening typically observed in polymeric systems containing salts or ionomers. Ionic domains may form, acting as pseudo-crosslinks in the ionically conductive regions or as crosslinks between the conductive region and the matrix polymer.

In preferred embodiments, the disbondable composition is a phase-separated composition having regions enriched in electrolyte having high ionic conductivity and regions enriched in matrix polymer having high mechanical or bonding strength. A phase-separating composition may comprise an initially miscible mixture of polymer resin and electrolyte. The electrolyte may segregate from the growing resin network during cure in a reactive system or during loss of compatibilizing solvent or temperature reduction in a thermoplastic polymer blend. Phase separation may be encouraged by increasing the molecular weight of the polymer resin, oligomeric (or polymeric) electrolyte additive, or both.

In preferred embodiments, phase separation results in regions having high ionic conductivity, forming a continuous pathway within the composition. Without a continuous pathway, ions are required to traverse the high strength, low-conductivity regions of the material during electrochemical disbanding. Bicontinuous or interpenetrating networks advantageously provide a continuous ionically conductive pathway without compromise to the mechanical strength of the adhesive polymer resin. Phase-separated compositions having the desired microstructure may be obtained by varying the relative proportions of the various components of the disbondable composition. For example, a composition comprising approximately equal parts by volume of polymer and electrolyte may cure to provide a continuous ionically conductive pathway.

The use of electrically disbanding adhesives is pertinent to a variety of applications. These include the bonding of packaging materials for the storage and transportation of goods; as a convenient means of opening metallized foil packages; and to provide packages and containers with anti-theft and anti-tamper features. Other applications include the assembly of components on automobiles, such as the attachment of mirrors, trim, interior covers and access panels, sensors, wire harnesses, and the like, as well as similar uses in connection with aircraft manufacture and in shipbuilding. Additional applications of the invention include the temporary attachment of packages to the exteriors of vehicles, including aircraft and ships; release mechanisms in which a signal, such as a remote signal, is used to command the separation of an adhesively bonded joint (e.g., for sensor and tracking devices temporarily bonded to vehicles, to goods in shipment, and to domesticated or wild animals); manufacturing operations in which parts must be temporarily held in place for machining, coating or other treatments; and the assembly of appliances and electronics when disassembly of these items is required for repair or for end-of-life recycling.

In a preferred embodiment, a hot-melt adhesive contains a thermoplastic polymer. Melting of this polymer provides the solid-to-liquid transformation required for application of the adhesive. Useful thermoplastic polymers may contain functionalities that promote miscibility with electrolytes. These polymers should also be compatible with other ingredients used in the adhesive composition, including other polymeric materials, and should form miscible blends with these polymers in the molten state. The thermoplastic polymers may be either crystalline or amorphous. Examples of suitable thermoplastic polymers include polyethylene, ethylene vinyl acetate copolymers, ethylene acrylic copolymers, polyamides, polyesters and polyesteramides. An exemplary crystalline thermoplastic polymer suitable for use in connection with the present invention is polycaprolactone. An amorphous thermoplastic polymer provides a solid-to-liquid transformation as the temperature is increased above the glass transition temperature (T_{g}) of the polymer. Examples of this type of polymer include polystyrene-polybutadiene-polystyrene block copolymers and polyamide copolymers. Suitable thermoplastic polymers may contain polar groups or functionalities that include hydroxyls, ethers, esters, ketones, carbonates, amides, imides, urethanes, ureas, nitriles, nitrates, sulfones, sulfates, phosphates and the like.

Hot-melt adhesives in accordance with the present invention may also contain polymers, oligomers, solvents, plasticizers, and their mixtures, that possess polar functionality. The polar functionality arises from the presence of functional groups that include hydroxyls, ethers, esters, ketones, carbonates, amides, imides, urethanes, ureas, nitriles, nitrates, sulfones, sulfates, phosphates and the like. These polar materials are capable of coordinating to ionic species and can dissolve ionic materials or electrolytes. It is advantageous if the polymers and oligomers used to coordinate ionic species are miscible in the molten state of the hot-melt adhesive. It is also advantageous if the ion-coordinating polymers or oligomers can also serve as a tackifier for the adhesive composition. Especially useful polymers with polar functionality include low-molecular-weight phenolic resins. These are condensation products of formaldehyde with phenol, alkylated phenol or cresol. An exemplary phenolic polymer is alkylated phenol-co-formaldehyde.

An ingredient typically added to a hot-melt adhesive is a tackifier. A tackifier is typically a low molecular weight, high-T_{g} polymer that is compatible with the thermoplastic. The tackifier provides rapid adhesion (tack) between the substrates and hot-melt in the molten state. It does this by improving the wetting characteristics of the hot-melt and by increasing the energy required to separate the adhesive from the substrate during disbonding through viscous flow. Exemplary tackifiers include terpene resins, rosin derivatives, cyclical aliphatic and aliphatic aromatic hydrocarbons (e.g., C₅ and C₉ resins) and low-molecular-weight phenolic resins.

The hot-melt adhesive of the present invention may contain a salt. The salt is preferably an ionic material possessing a hard-acid cation combined with a soft-base anion and may include alkali metal, alkaline earth metal, ammonium, perchlorate, tetrafluoroborate, hexafluorophosphate, hexafluoroantimonate, hexafluoroarsenate, trifluorosulfonate (triflate), bis(trifluoromethylsulfon)-imide (triflimide), thiocyanate and/or iodide species. Exemplary salts include lithium perchlorate, sodium perchlorate and lithium triflimide.

Hot-melt adhesive compositions in accordance with the present invention may include plasticizing oils and solvents. These lower the viscosity of the molten adhesive and aid in surface wetting and bond formation. Solvents are desirably chosen for compatibility with the major adhesive ingredients. A suitable solvent should not interfere with polymer solidification and should have a reasonably low vapor pressure at the temperatures at which the adhesive is applied. The electrical release function of the hot-melt adhesive composition benefits from the presence of a liquid material in the mixture. While not being constrained to any particular mechanism, this liquid may serve as a plasticizer providing enhanced ionic conductivity, as an electrolyte solvent, an ion carrier or may physically aid in release at the interface between the adhesive and the substrate. This liquid may be a solvent or oligomer as described above. Especially useful as liquids are polyethers, esters, ketones and nitriles.

Plasticizing solvents used in hot-melt compositions should be miscible with the thermoplastic polymer in the molten state, but should not inhibit crystallization of the thermoplastic when the hot-melt adhesive is cooled. Examples of melt miscible solvents, from which the thermoplastic polycaprolactone may precipitate on cooling, include: dipentene, tetrahydronaphthelene, tetrachloroethylene, n-butanol, 2-ethyl hexanol, cyclohexanol, diethylene glycol monobutyl ether digol, diethylene glycol monoethyl ether, 2-ethoxy ethanol, 2-butoxy ethanol, dipropylene glycol, polypropylene glycol (400 MW), allyl alcohol, diacetone alcohol, butyl acetate, 2-ethoxy ethyl acetate, amyl acetate, methyl cyclohexyl acetate, ethyl acetoacetate, n-amyl formate, n-butyl propionate, di-ethyl carbonate, diethyl adipate, dimethyl phthalate, di-n butyl phthalate, γ-butyrolactone, triethyl phosphate, isobutyl methyl ketone, methyl n-propyl ketone, methyl isoamyl ketone, methyl n-hexyl ketone, diethyl ketone, diacetone alcohol, isophorone, dimethyl acetamide, dimethyl sulphoxide, di-allyl phthlate, di n-butyl fumarate and di n-butyl maleate. Preferably the solvent contains ion-coordinating or otherwise polar functional groups and further exhibits a high boiling point and low vapor pressure. Exemplary melt-miscible solvents that enhance the electrical disbonding function include γ-butyrolactone, polypropylene glycol (400 MW), and mixtures thereof. An additional exemplary solvent that enhances electrical disbonding is tetraethylene glycol dimethyl ether. Though not miscible with some exemplary thermoplastics in the molten state, mixtures of this solvent with molten thermoplastics may be compatibilized by the presence of SP-25 and/or other phenolic resins. The miscibility of these plasticizing solvents with the tackifying resin promotes ionic conductivity after crystallization and phase separation of the thermoplastic polymer.

More specifically, in the melt, the hot-melt adhesive compositions form a homogeneous liquid mixture. As this mixture cools, the main polymer (e.g., polycaprolactone) crystallizes. Only pure materials crystallize, so the polymer separates from the other ingredients during crystallization, forming the primary load-bearing phase. The other ingredients (salts, solvents/plasticizers/tackifying polymers) form a second phase, which is ionically conductive and presumed to be continuous. To some extent this second phase also contains a fraction of the main polymer, which did not crystallize. There is thus some connectivity between the two phases.

Additional ingredients in the hot-melt adhesive composition may include oxidation inhibitors, stabilizers such as hindered phenolic compounds, fillers and/or wax. Wax is used to lower the viscosity in the melt and to control melt and solidification properties. During solidification, the wax phase separates to form crystalline microparticles that act as a reinforcement. The wax also lowers the surface tack of the solidified adhesive and can be used to prevent solidified adhesive materials from sticking together. An exemplary wax is a microcrystalline wax. Other exemplary waxes include paraffin wax, Fischer-Tropsch wax and PEG based Carbowax (Union Carbide).

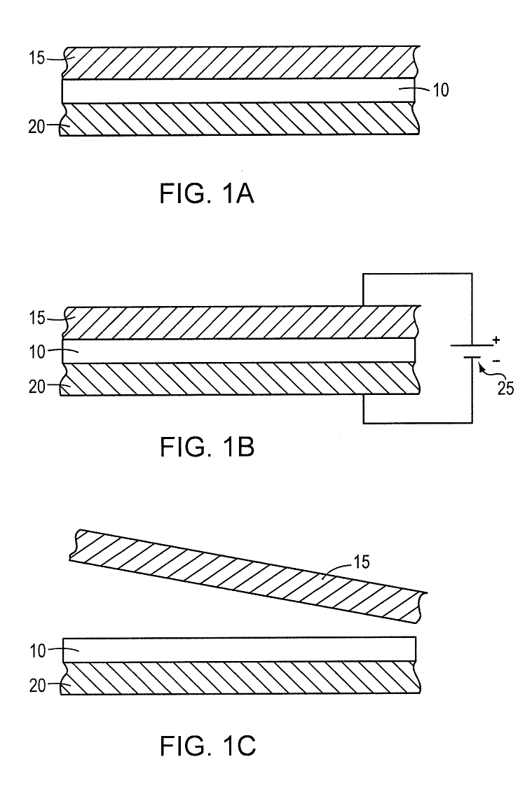

FIG. 1A illustrates a representative embodiment of the invention, in which a hot-melt adhesive 10 is used to form a bond between two metal surfaces 15, 20. As shown in FIG. 1B, the adhesive bond is weakened by connecting a voltage source 25 to the metal surfaces. The adhesive bond between the metal surface 15 connected to the positive terminal of the voltage source 25 and the hot-melt adhesive 10 is weakened. Metal surface 20 is then readily separated from the hot-melt adhesive (FIG. 1C), leaving surface 20 substantially free of adhesive 10. Desirably, the bond between the hot-melt adhesive and the surface to which it is bonded is weakened without melting the adhesive.

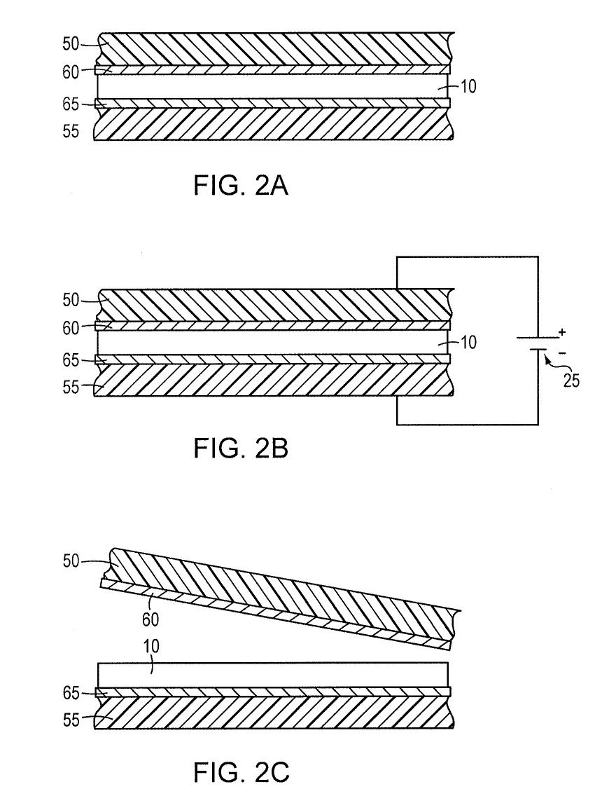

As shown in FIG. 2A, it may be necessary to bond surfaces that are not metallic and do not exhibit electronic conductivity. Surfaces 50, 55, which are not electronically conducting, may be coated with a thin layer of conductive material that forms an electronically conducting surface 60, 65. The conductive material may be, for example, an ink loaded with graphite or carbon powder. The ink is applied as a liquid that subsequently dries to form a thin, well-bonded conductive surface 60, 65 over the non-conducting surfaces 50, 55. The adhesive bond 10 is weakened by connecting the voltage source 25 to the electronically conducting surfaces 60, 65 (FIG. 2B). In some embodiments, the adhesive bond to the conducting surface 60 connected to the positive terminal of the voltage source 25 and the hot-melt adhesive 10 is weakened. As shown in FIG. 2C, conducting surface 60 is then readily separated from the hot-melt adhesive 10, leaving surface 60 substantially free of adhesive 10.

Other conductive coatings may be employed in the same way as the carbon- or graphite-loaded inks. Other exemplary conductive coatings include liquid compositions containing metal particles as electronic conductors, prior-art hot-melts containing electronically conducting fillers, and conventional adhesives, such as epoxies, containing electronically conducting fillers. Other methods of providing electronic conductivity to otherwise non-conducting surfaces include laminating the non-conducting surface with a thin metallic foil, spraying the non-conductive surface with electronically conducting particles, and depositing a thin electronically conducting metal layer by vacuum deposition methods such as thermal evaporation or sputtering.

In the foregoing embodiments, the hot-melt adhesive bond is shown being substantially weakened at the interface between the adhesive and the conductive surface connected to the positive terminal of the voltage source. As shown by example (e.g., Example 12), hot-melt adhesives in accordance with the present invention may also be formulated to weaken substantially at the interface between the adhesive and the conductive surface connected to the negative terminal of the voltage source. Weakening of both interfaces may be achieved, for example, by connecting the voltage source until one interface is weakened and then reversing the polarity of the voltage source until the other interface is weakened. Both conductive surfaces are then readily separated from the hot-melt adhesive.

A feature of embodiments of the invention is the low current and correspondingly low charge required to weaken a bond. As shown by example (Example 13), a hot-melt adhesive containing γ-butyrolactone (Table 1, Example 8), with an initial lap shear strength of 250 psi, is weakened to a lap shear strength of 25 psi after 110 sec by the application of 50 V. The average current during disbanding is 80 μA/cm² and the total charge transferred is 8.6 millicoulombs (mC) per cm². The average power to disbond is <4 mW (mW) per cm². The average current and power values are representative and depend on the magnitude of the disbanding voltage, the ambient temperature, the load on the bond, and the thickness of the adhesive bond, among other factors. The charge passed during disbanding is also representative and not limiting. At a disbanding voltage of 50 V, preferred average current densities are less than 1 milliampere (mA) per cm² and power densities are less than 50 mW/cm². Preferred levels of charge to disbond are less than 100 mC/cm².

The voltage used to weaken the adhesive bond is not critical. In general, higher voltages result in more rapid weakening of the bond and the voltage is chosen to achieve the desired level of weakening in a time appropriate for a particular use. A preferred voltage range is from 5 V to 50 V dc. Voltages from 1 V to 200 V dc are also contemplated. Higher voltages are generally not desirable for safety but are still effective in weakening the adhesive bond.

In an embodiment, the hot-melt adhesives of the present invention contain an electrolyte salt that provides ionic conductivity. The ionic conductivity is preferably between 10⁻⁵ S/cm and 10⁻⁸ S/cm. In general, adhesives exhibiting higher conductivities will demonstrate more rapid disbanding but at the expense of reduced strength. Low-conductivity adhesives are frequently stronger but exhibit slower disbanding. Hot-melt adhesives may be formulated to provide the desired strength and disbanding time for a particular use. Thus, ionic conductivities in the range 10⁻⁴ S/cm to 10⁻⁹ S/cm are also contemplated by the invention.

### EXAMPLES

### Example 1

An electrically releasing hot-melt adhesive was formulated by mechanically mixing 4.95 grams of polycaprolactone (Mn 42,500 AMU with 0.5 gram of finely divided poly(epichlorohydrin) rubber (Hydrin C2000XL, Zeon Chemicals) at 150° C. until the rubber dissolved. This mixture was combined with 2.48 grams of phenolic resin (SP-25, SI Group), which serves as the tackifier, 0.25 gram of sodium perchlorate electrolyte and 0.55 gram of microcrystalline wax (softening point 85-90° C.). The composition was then mixed at 150° C. until well blended. Finally, 1.2 grams of tetraethylene glycol dimethyl ether (tetraglyme) plasticizer were stirred into the composition along with 0.1 gram of water. The mixture was cooled to room temperature forming a solid suitable for use as a hot-melt adhesive.

An electrically releasing bond was fabricated using this composition to bond two aluminum surfaces by first heating the composition until molten (between 120-150° C.) and then applying the molten adhesive to one of the aluminum surfaces. A second aluminum surface was then pressed onto the molten adhesive on the first surface and the assembly was allowed to cool until the adhesive solidified, forming a hot-melt adhesive bond between the two surfaces. Solidification occurred within one minute. The tensile strength of the bonded assembly, measured perpendicular to the bonded surfaces, was 450 psi as determined using a tensile test machine (Instron Model 4002). To electrically disbond the assembly, a 50-volt power source (dc) was connected to the aluminum surfaces. Tensile strength measurements demonstrated a reduction in adhesive bond strength to 150 psi after 1 minute of applying the voltage and a further reduction to 100 psi after 5 minutes of electrical treatment. The bond was weakened most effectively at the interface between the hot-melt adhesive and the anodic (positive) conducting substrate. Electrical disbonding in this example and in all examples described below was performed at room temperature (20° C.).

### Example 2

An electrically releasing hot-melt adhesive exhibiting substantially total reduction in adhesive bond strength was formulated by mixing 4.47 grams of polycaprolactone (Mn. 44.5K) and 1.12 grams of polyepichlorohydrin rubber at 150° C. and mechanically stirring until the rubber dissolved in the molten polycaprolactone. To this mixture was then added 1.12 grams of SP-25 phenolic resin, 1.12 grams of pentaerythritol tetrabenzoate, 0.22 gram of sodium perchlorate and 0.34 gram of paraffin wax (softening point 54° C.). The mixture was heated at 150° C. and stirred until a homogeneous blend was obtained. To this were added 1.57 grams of tetraglyme and 0.05 gram of water. The blend was stirred and then cooled to room temperature.

Bonded specimens are fabricated with this composition following the procedure described in Example 1. Bonds formed between aluminum surfaces exhibited a tensile strength of 175 psi, which decreased to <10 psi after application of 50 V dc across the bondline for one minute. The bond was weakened most effectively at the interface between the hot-melt adhesive and the anodic (positive) conducting substrate.

### Example 3

An electrically releasing hot-melt adhesive exhibiting both a high initial adhesive strength and low residual adhesive strength after electrical disbonding was formulated by blending of 4.8 grams of polycaprolactone (Mn 44.5K) with 0.48 gram of polyepichlorohydrin rubber at 150° C. and stirring until the rubber dissolved in the molten polymer. To this mixture were then added 2.4 grams of SP-25, 0.48 gram of pentaerythritol tetrabenzoate, 0.24 gram of sodium perchlorate and 0.36 gram of paraffin wax. The mixture was stirred further at 150° C. until a homogeneous liquid was formed. To this were added with mixing 1.2 grams of tetraglyme and 0.05 gram of water. The mixture was then cooled to room temperature.

Aluminum surfaces specimens fabricated with this hot-melt adhesive composition exhibited a tensile strength of 600 psi, dropping to <10 psi after 50 V was applied across the bondline for 3 minutes. The bond was weakened most effectively at the interface between the hot-melt adhesive and the anodic (positive) conducting substrate.

### Example 4

In a test of the use of alternative electrolytes, samples were also formulated using lithium trifluoromethane sulfonamide (triflimide). With this electrolyte, much lower levels of plasticizing solvents are required to achieve electrical disbanding. Electrical disbanding is observed in samples comprising 55.9% by weight polycaprolactone (44.5 k), 13.1% by weight poly(epichlorohydrin), 26.1% SP-25 phenolic resin, 3.9% paraffin wax and only 2.6% tetraglyme and 2.1% lithium triflimide.

### Example 5

Specimens formed using a composition comprising 56% by weight polycaprolactone (44.5 k), 11.5% by weight poly(epichlorohydrin), 23% by weight SP-25 phenolic resin, 3.5% by weight paraffin, 11.5% by weight tetraglyme and 4.6% by weight lithium triflimide exhibit a tensile bond strength of 500 psi on aluminum substrates, dropping to 250 after application of 50 V dc for one minute. Bond strength drops to <10 psi after five minutes of electrical treatment with 50 volts.

### Example 6

Electrical disbanding behavior was observed in a wide variety of polycaprolactone-based compositions where either phenolic resin or poly(epichlorohydrin) was present in the formulation. For instance, good bond strengths and disbanding properties are obtained from a composition comprising 51.9% by weight polycaprolactone (Mn. 44.5 k), 26% by weight SP-25 phenolic resin, 5.2% by weight lithium triflimide (electrolyte), 13% by weight tetraglyme and 3.9% by weight paraffin wax despite having no poly(epichlorohydrin) rubber in the formulation. Exceptional disbanding properties were also observed in samples fabricated using a composition comprising 47.8% polycaprolactone, 5% poly(epichlorohydrin), 23.9% pentaerythritol tetrabenzoate, 4.8% lithium triflimide and 11.4% tetraglyme, despite the absence of SP-25 phenolic resin. However, while exhibiting good bond strength to aluminum and possessing a reasonably high level of ionic conductivity, a mixture comprising 51.9% polycaprolactone (44.5 k), 26% pentaerythritol tetrabenzoate, 5.2% triflimide, 13% tetraglyme and 3.9% by weight paraffin wax does not electrically disbond even after application of 50 V for one hour. This composition contains neither poly(epichlorohydrin) rubber nor phenolic resin.

### Example 7

Effect of Plasticizer/Solvent: A standard composition was prepared by blending together 10 grams of polycaprolactone (44.4 k) with 1 gram of Hydrin rubber, 5 grams of SP-25 phenolic resin, 0.5 gram of sodium perchlorate, 0.75 gram of microcrystalline wax, and 0.2 gram of water. To this was added various solvents as listed in Table 1. Tensile strengths for bonds formed between aluminum fixtures are listed along with residual strengths after application of 50 V across the bondline for specific lengths of time.

TABLE 1

| | | Tensile Strength (psi) | | |
|---|---|---|---|---|
| | | After Application of 50 Volts d.c. | | |
| Solvent/plasticizer | Initial Tensile Strength (psi) | 1 minute | 2 minutes | 3 minutes |
| 2.5 grams Tetraglyme | 320 | | 160 | |
| 2.5 grams Propylene Carbonate | 510 | | 350 | 220 |
| 2.5 grams Ethylene Carbonate | 475 | | 125 | 60 |
| 2.5 grams γ-Butyrolactone | 425 | 50 | 0 | |
| 2.5 grams Tributyl Phosphate | No Disbonding | | | |
| 1 gram Tetraglyme | 160 | 15 | 0 | |
| 1.5 grams Nitromethane | | | | |

Of the several solvents tested in this composition, that formulated with γ-butyrolactone provides the best overall electrical disbanding performance with aluminum substrates. Hot-melt compositions formulated with ethylene carbonate also exhibit a useful range of properties and disbond performance. However, after several weeks, bonds formed with this composition were found to suffer a loss in both conductivity and disbond performance, due to crystallization of the ethylene carbonate within the solidified adhesive.

Longer-term aging studies suggest that compositions formulated with γ-butyrolactone provide the most stable bonds of the solvents tested. Virtually no loss in bond strength was observed after six months for bonds formulated with this composition. Bonds formed using compositions formulated with tetraglyme, on the other hand, exhibited a significant loss in strength after only three months. This is apparently due to Ostwald ripening and the consequent bleeding of tetraglyme to the adhesive/metal interface. The γ-butyrolactone does have a low, but not insignificant, room-temperature vapor pressure (1.5 mm Hg at 20° C.). This leads to loss of solvent from the composition and a noticeable loss in conductivity over time. Nevertheless, bonds fabricated using the γ-butyrolactone composition can still be electrically disbanded after six months.

### Example 8

The combination of ingredients used to formulate electrically disbanding hot-melt adhesive compositions should be compatible. The use of other polyesters as alternatives to polycaprolactone may require adjustment of the tackifying and/or ionically conductive ingredients in order to achieve a stable adhesive composition. For instance, a composition formulated by blending 10 grams poly(ethylene succinate) (Sigma-Aldrich), instead of polycaprolactone together with 1 gram of Hydrin rubber, 5 grams of SP-25 phenolic resin, 0.5 gram of sodium perchlorate, 2.5 grams of tetraglyme, 0.75 gram of microcrystalline wax and 0.2 gram of water does not provide useful adhesive properties due to gross phase separation of the ingredients upon cooling. However, substitution of poly(1,4-butylene adipate-co-caprolactam), a crystalline polyester/polyamide copolymer (Tₘₑₗₜ=125° C.), into this composition provides a material that exhibits both adhesive and electrical disbanding properties.

### Example 9

Another example of an electrically disbanding hot-melt adhesive that employs an alternate thermoplastic polymer is formulated by blending together a mixture of 1.5 grams of poly(ethylene-co-vinyl acetate) (40% vinyl acetate) and 1.5 grams of SP-25 phenolic resin in the molten state at 150° C.. To this mixture are added 0.25 gram of sodium perchlorate, 0.5 gram of N-octyl pyrrolidone and 0.25 gram of microcrystalline wax. Heating and stirring is continued until the salt is dissolved and the mixture became homogeneous. Finally, 0.5 gram of tetraglyme is added and the mixture is cooled to room temperature. This hot-melt composition forms low strength rubbery bonds between aluminum substrates. After application of 50 V for three minutes, the bonds fall apart. The loading of thermoplastic polymer in this composition is 33% by weight.

### Example 10

Advantageous mechanical properties can be achieved by blending poly(ethylene-co-vinyl acetate) with polycaprolactone. A mixture of 1 gram of polycaprolactone (Mn 80 k), 1 gram of poly(ethylene-co-vinyl acetate) (40% vinyl acetate), 1.5 grams of SP-25 phenolic and 0.28 gram of microcrystalline wax is blended together in the melt at 150° C. until a homogeneous mixture is formed. To this are added 0.25 gram of sodium perchlorate dissolved in 0.75 gram of tertraglyme, 0.5 gram of N-octyl pyrrolidone and 0.5 gram of 2-cyanoethyl ether. The mixture is then cooled to room temperature. This composition can be used to form high-strength bonds between aluminum substrates, which fall apart after application of 50 V across the bondline for 5 minutes.

### Example 11

Hot-melt Adhesive Composition for Electrically Disbonding from Carbon Ink: A mixture of 3 grams of polycaprolactone (Mn 80 k), 1 gram of polycaprolactone (Mn 10K), 3 grams of SP-25 phenolic resin and 0.3 gram of microcrystalline wax is heated at 150° C. and stirred until the molten mixture is homogeneous. To this are added 0.2 gram of sodium perchlorate dissolved in 0.7 gram of tetraglyme, 1 gram of N-octyl pyrrolidone, 0.4 gram of 2-cyanoethyl ether and 0.1 gram of water. The mixture is then solidified by cooling to room temperature.

This formulation forms very weak bonds to aluminum surfaces, but bonds strongly to ink-coated paper products. Using the composition described in this example, specimens were fabricated by bonding together cardboard swatches coated with electrically conducting ink (120-24, Creative Materials). These specimens were easily separated after application of 50 V dc across the bondline. Disbonding occurred at the positive interface.

### Example 12

Hot-melt Adhesive Composition Disbonding at the Negative Surface: A mixture of 1 gram of polycaprolactone (80 k), 1 gram of polycaprolactone (MW=10,000) and 0.5 grams of SP-25 phenolic resin was mixed together in the molten state at 150° C. until homogeneous. To this mixture was added 1.0 gram of poly(propylene glycol) (400 amu). The mixture was stirred at 150° C. until well blended. Finally, 0.2 gram of sodium perchlorate dissolved in 0.4 gram of tetraglyme were stirred into this mixture along with 0.05 gram of water. The mixture was then solidified by cooling to room temperature.

This formulation bonds strongly to both aluminum and to graphite ink-coated paper products. Bonded graphite ink-coated cardboard specimens, fabricated using this formulation, were easily separated after application of 50 V dc across the bondline for 20 minutes. The sample separated at the interface between the adhesive and cathodic (negative) ink surface.

Improved strength and disbonding were obtained by using a block copolymer to formulate this composition. The block copolymer was formed by mixing 1 gram of poly(propylene glycol) (400 amu) with 1 gram of polycaprolactone (80 k) and heating at 150° C. for 24 hours. The block copolymer forms by ester exchange between the terminal hydroxyl groups of the PPG and the internal ester linkages of the polycaprolactone. An adhesive composition was formulated by blending 2 grams of this block copolymer mixture with 1 gram of polycaprolactone (Mn 80 k) and 0.5 gram of SP-25 phenolic resin. This mixture was heated at 150° C. and stirred together in the molten state until a homogeneous liquid was formed. To this mixture were added 0.2 gram of sodium perchlorate dissolved in 0.4 gram of tetraglyme and 0.05 gram of water.

### Example 13

A hot-melt adhesive composition was prepared from by blending 10 grams of polycaprolactone (44.4 k) with 1 gram of Zeon rubber, 5 grams of SP-25 phenolic resin, 2.5 gram γ-butyrolactone, 0.5 gram of sodium perchlorate, 0.75 gram of microcrystalline wax, and 0.2 gram of water (Example 7). A lap shear bond between two aluminum surfaces was formed with the composition. The shear strength of a similar bond was determined to be 250 psi by mechanical testing in an Instron tensile test apparatus. A load of 25 psi in shear was then applied to the bond. With the latter load applied, a 50 V source was connected between two the aluminum surfaces and the current flowing between the surfaces measured as a function of time. After 110 sec, the bond separated at the positive aluminum surface as the strength of that interface was weakened to less than 25 psi. The average current recorded over the 110 sec disbond time was 78 μA/cm² (bond area) and the average power <4 mW/cm². The charge passed during disbanding was 8.6 mC/cm², calculated from the time integral of the current over the disbond period.

### Example 14

A hot-melt adhesive composition was prepared from by blending 10 grams of polycaprolactone (44.4 k) with 1 gram of Zeon rubber, 5 grams of SP-25 phenolic resin, 2.5 gram γ-butyrolactone, 0.5 gram of sodium perchlorate, 0.75 gram of microcrystalline wax, and 0.2 gram of water (Examples 7 and 13). A lap shear bond between two aluminum surfaces was formed with the composition. The shear strength of a similar bond was determined to be 250 psi by mechanical testing in an Instron tensile test apparatus. A load of 25 psi in shear was then applied to the bond. With the latter load applied, 8.5 V was connected between the two aluminum surfaces and the current flowing between the surfaces measured as a function of time. The bond separated after 495 sec. The average current recorded over the 495 sec disbond time was 6.2 μA/cm² (bond area) and the average power 0.05 mW/cm². The charge passed during disbanding was 3.0 mC/cm². This example demonstrates that low-voltage disbanding is efficiently obtainable.

What is claimed is:

1. A hot-melt adhesive composition comprising:
a thermoplastic component; and
an electrolyte, wherein the electrolyte provides sufficient ionic conductivity to the composition to enable a faradaic reaction at a bond formed between the composition and an electrically conductive surface and allow the composition to disbond from the surface.

2. The composition of claim 1 wherein the thermoplastic component comprises a thermoplastic polymer.

3. The composition of claim 1 further comprising a tackifier.

4. The composition of claim 1 further comprising a wax.

5. The composition of claim 1 further comprising a second thermoplastic component capable of coordinating ions.

6. The composition of claim 1 further comprising a salt.

7. The composition of claim 2 wherein the thermoplastic component comprises at least one of of ethylene vinyl acetate copolymers, ethylene acrylic copolymers or polyesteramides.

8. The composition of claim 3 wherein the tackifier comprises at least one of a terpene resin, a rosin derivative, a cyclical aliphatic hydrocarbon, an aliphatic aromatic hydrocarbon, or a low-molecular-weight phenolic resin.

9. The composition of claim 4 wherein the wax comprises at least one of microcrystalline waxes, paraffin wax, Fischer-Tropsch wax or PEG-based waxes.

10. The composition of claim 5 wherein the second thermoplastic is an alkylated phenol-co-formaldehyde.

11. The composition of claim 6 wherein the salt is sodium perchlorate.

12. The composition of claim 1 wherein the composition has an ionic conductivity between 10⁻⁵ S/cm and 10⁻⁸ S/cm.

13. The composition of claim 1 wherein the adhesive bond is substantially weakened by the passage of 100 mC/cm² of bond area.

14. The composition of claim 1 wherein the electrolyte functionality comprises an ion-solvating molecule selected from the group consisting of low molecular weight alkoxides, alcohols, alkyl carbonates, cyclic esters, nitriles, amides and ureas.

15. The composition of claim 1 further comprising a plasticizing oil.

16. The composition of claim 1 further comprising a solvent.

17. The composition of claim 1 further comprising an oxidation inhibitor.

18. The composition of claim 1 further comprising a stabilizer.

19. An adhesive composition comprising:
a polymer; and
an electrolyte, wherein the electrolyte provides sufficient ionic conductivity to the composition to enable a faradaic reaction at a bond formed between the composition and an electrically conductive surface and allow the composition to disbond from the surface at room temperature.

20. A method of forming an electrically weakening adhesive bond, the method comprising the steps of:
applying a hot-melt adhesive to a first electrically conductive surface;
contacting the hot-melt adhesive with a second electrically conductive surface;
allowing formation of an adhesive bond; and
applying a voltage between the electrically conducting surfaces whereby adhesion at at least one interface between the hot-melt adhesive and a conductive surface is substantially weakened.

21. A method of forming an electrically weakening adhesive bond, the method comprising the steps of:
applying a hot-melt adhesive to a first electrically conductive surface;
contacting the hot-melt adhesive with a second electrically conductive surface;
allowing formation of an adhesive bond;
applying a voltage of a first polarity between the electrically conducting surfaces; and
applying a voltage of a second polarity between the electrically conducting surfaces, the second polarity being the reverse of the first polarity, whereby adhesion at the interfaces between the hot-melt adhesive and the conductive surfaces are substantially weakened.

22. The method of claim 20 wherein the voltage is between 5 V and 100 V.

23. The method of claim 21 wherein the voltage is between 5 V and 100 V.

24. The method of claim 20 wherein the adhesive bond is weakened without melting the adhesive.

25. The method of claim 21 wherein the adhesive bond is weakened without melting the adhesive.
